(19) United States
(12) Patent Application Publication
(10) Pub. No.: US 2024/0356054 A1
(43) Pub. Date: Oct. 24, 2024

(54) ION-SELECTIVE HALF-CELL AND ITS MANUFACTURING PROCESS

(71) Applicant: Endress+Hauser Conducta GmbH+Co. KG, Gerlingen (DE)

(72) Inventors: Christian Fanselow, Geringswalde (DE); Holm Petzold, Dresden (DE); André Pfeifer, Schkopau (DE)

(21) Appl. No.: 18/633,818

(22) Filed: Apr. 12, 2024

(30) Foreign Application Priority Data
Apr. 21, 2023 (DE) 10 2023 110 233.8

(51) Int. Cl. H01M 8/1088; H01M 8/1004; H01M 8/1067

(52) U.S. Cl. CPC H01M 8/1088; H01M 8/1004; H01M 8/1067

(57) ABSTRACT

The present disclosure relates to an ion-selective half-cell comprising a carrier that extends in a sleeve-like manner along an axis and has a first open end and a second end opposite the first open end, an insert that extends in a sleeve-like manner along the axis and is arranged in the first open end, a membrane that is arranged in the first open end and at least partially in the insert in such a way that the first open end is closed by the membrane, an electrolyte that is arranged in the carrier and is in electrolytic contact with the membrane, and a lead that is arranged in the carrier and is in electrical contact with the electrolyte.

### CROSS-REFERENCE TO RELATED APPLICATION

The present application is related to and claims the priority benefit of German Patent Application No. 10 2023 110 233.8, filed on Apr. 21, 2023, the entire contents of which are incorporated herein by reference.

### TECHNICAL FIELD

The present disclosure relates to an ion-selective half-cell and to a manufacturing process of an ion-selective half-cell.

### BACKGROUND

An ion-selective electrode, also known as an ion-specific or ion-sensitive electrode (ISE), serves as a sensor for the concentration or, more precisely, the activity of a specific dissolved ion. For the measurement, the ion-selective electrode (1st half-cell) and a second electrode (2nd half-cell), the reference electrode, are immersed in a medium to be measured, and the voltage between the two electrodes is measured. This allows the desired concentration to be determined. The measurand is a concentration-dependent voltage to the reference electrode. According to the Nernst equation, this voltage depends logarithmically on the activity of the ion in question. The best known ion-selective electrode is the pH electrode, which responds to protons (hydrogen ions or hydronium ions). Ion-selective electrodes are used in many fields, for example in analytical chemistry including environmental analysis, in biochemical and biophysical research, and in industrial processes, in particular process automation technology.

The central component of the ISE is an ion-selective membrane which separates a reference solution with a lead contained in an electrode housing from the solution to be determined. The membrane has a composition that varies depending on the ion to be determined. The most important membrane types are crystalline or vitreous solids or composites with polymers.

The membranes are usually cast as flat base membranes; a polymer solution, for example PVC with softeners and ionophores, is used as a casting solution in a suitable solvent, for example THF. After drying, small pieces are cut out or punched from the base membrane. These membranes are usually clamped or glued in order to install them in caps in a liquid-tight manner (shunt free) in an ISE half-cell.

Clamping as a force fit causes stress on the membrane, which can in turn lead to leakage. Due to settling, a significant decrease in the force on the soft membrane fit is to be expected in a relatively short time. Furthermore, a leaching of the softener leads to a shrinking of the membrane. The combination of the membrane settling and the membrane shrinking causes shunts after prolonged use, resulting in a loss of measuring characteristics. In order to compensate for settling and shrinking of the membrane, a clamping device that is costly in terms of design and manufacturing is necessary. The clamping device is comprised of two membrane placement surfaces that can be displaced relative to one another. Both must tightly seal the outer and inner spaces, which requires the use of different sealing elements. Furthermore, the contact pressure force of the two membrane placement surfaces must be well matched to the consistency of the membrane. Clamping devices must be checked for impermeability.

Adhesive may influence the properties of the membranes, and it is not absolutely certain that it is stable in the long term. Adhesion points must be pre-treated and checked for impermeability.

### SUMMARY

It is therefore an object of the present disclosure to provide an ion-sensitive half-cell that is reliable, safe and can be used for a long time.

The object is achieved by an ion-sensitive half-cell according to the present disclosure.

The ion-selective half-cell according to the present disclosure comprises: a carrier that extends in a sleeve-like manner along an axis and has a first open end and a second end opposite the first open end, an insert that extends in a sleeve-like manner along the axis, and is arranged in the first open end, a membrane that is arranged in the first open end and at least partially in the insert in such a way that the first open end is closed by the membrane, an electrolyte that is arranged in the carrier and is in electrolytic contact with the membrane, a lead that is arranged in the carrier and is in electrical contact with the electrolyte.

The ion-sensitive half-cell according to the present disclosure allows a reliable and safe measurement on the lead over a long period of use of the ion-sensitive half-cell. The insert in which the membrane is at least partially arranged in particular reduces diffusion of softeners from the membrane into the carrier. This slows down the process of the above-described shrinkage of the membrane. The duration of use or lifetime of the membrane is thus increased. The present disclosure can extend the service life of directly cast-on membranes. The insert is effective in limiting softener diffusion between the directly bonded membrane and the carrier. This results in an extension of the service life of half-cells, in particular of nitrate half-cells, because the softener used here diffuses particularly quickly into the carrier.

According to one embodiment of the present disclosure, the insert has a bottom in which at least one passage opening is formed, wherein the membrane is in electrolytic contact with the electrolyte through the passage opening.

According to one embodiment of the present disclosure, the insert has an insert diameter that spans an insert surface, wherein the at least one passage opening defines a passage diameter, and the passage diameter is less than 50% of the insert surface, preferably less than 10% of the insert surface.

According to one embodiment of the present disclosure, the carrier has a projection that extends radially with respect to the axis so that the insert is secured against an axial displacement along the axis at least in one direction.

According to one embodiment of the present disclosure, an adhesive layer is arranged in the insert, wherein the adhesive layer is a fabric, for example.

According to one embodiment of the present disclosure, the carrier has a recess at the first open end, which recess extends over a recess length along the axis, wherein the recess is suitable for receiving the insert and the membrane, wherein the insert extends along the first axis with an insert length, and the insert length is smaller than the recess length so that the membrane is partially in direct contact with the carrier.

According to one embodiment of the present disclosure, the carrier comprises a first plastic that is suitable for being integrally bonded to the membrane, wherein the first plastic comprises, for example, PVC, ASA or ABS, wherein the insert comprises a second plastic different from the first plastic, for example PEEK or another material, wherein the second plastic or the other material has softener-inhibiting properties, wherein the membrane comprises a third plastic different from the second plastic, for example ASA, ABS, PVC, with a softener.

The aforementioned object is likewise achieved by a manufacturing process according to the present disclosure.

The manufacturing process according to the present disclosure comprises at least the following steps: providing a carrier that extends in a sleeve-like manner along an axis and has a first open end and a second open end opposite the first open end, introducing an insert into the first open end, wherein the insert extends in a sleeve-like manner along the axis, introducing a membrane into the first open end and the insert such that the first open end is closed by the membrane, introducing an electrolyte into the carrier so that the electrolyte is in electrolytic contact with the membrane, introducing a lead into the electrolyte.

According to one embodiment of the present disclosure, the step of introducing the insert takes place by pressing the insert in the carrier.

According to one embodiment of the present disclosure, a step of introducing an adhesive layer into the insert takes place before the step of introducing the membrane.

### BRIEF DESCRIPTION OF THE DRAWINGS

The present disclosure is explained in more detail on the basis of the following description of the figures. In the figures:

FIG. 1 shows a schematic sectional view of an ion-sensitive half-cell according to the present disclosure with a first embodiment of an insert,

FIG. 2 shows an enlarged spatial representation of the insert shown in FIG. 1,

FIG. 3 shows a sectional view of the insert shown in FIG. 2,

FIG. 4 shows an enlarged spatial representation of an alternative embodiment of an insert,

FIG. 5 shows a sectional view of the insert shown in FIG. 4,

FIG. 6 shows an enlarged spatial representation of an alternative embodiment of an insert,

FIG. 7 shows a sectional view of the insert shown in FIG. 6 with an adhesive layer.

### DETAILED DESCRIPTION

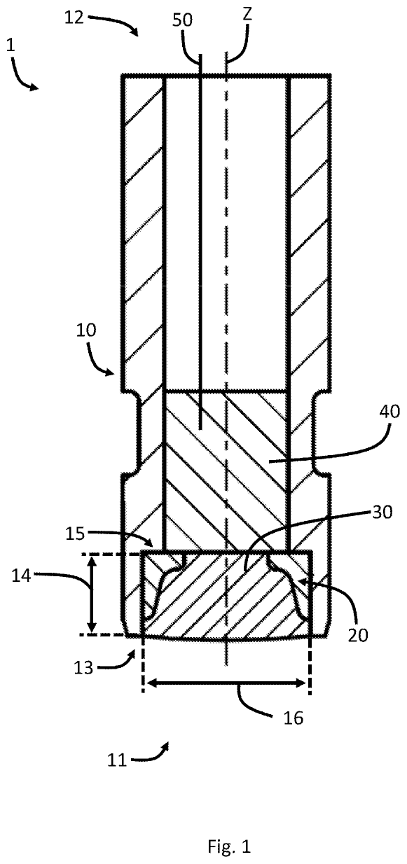

FIG. 1 shows an embodiment of an ion-sensitive half-cell 1 according to the present disclosure. The ion-sensitive half-cell 1 comprises a carrier 10, an insert 20, a membrane 30, an electrolyte 40, and a lead 50.

The carrier 10 extends in a sleeve-like manner along an axis Z and has a first open end 11 and a second end 12 opposite the first open end 11. The second end 12 is preferably an open end. The carrier 10 is made of a first plastic or comprises at least one plastic. In the following, plastic is also understood to mean plastic mixtures including those that do not contain only polymers. The carrier 10 preferably comprises PVC. Depending on the type of polymer builder in the membrane 30, a person skilled in the art will select a plastic for the carrier 10 that can be integrally bonded to the membrane 30. If, for example, the membrane 30 comprises PVC, the carrier 10 preferably also comprises PVC.

The carrier 10 preferably has a recess 13 at the first open end 11, which extends over a recess length 14 along the axis Z, wherein the recess 13 is suitable for receiving the insert 20 and the membrane 30. The recess 13 has a recess diameter 16 that extends transversely to the axis Z.

The insert 20 extends with an insert length 26 along the axis Z, and the insert length 26 is less than the recess length 14 so that the membrane 30 is partially in direct contact with the carrier 10, and an integral bond to the carrier 10 is ensured. The recess 13 is preferably designed such that when the insert 20 and the membrane 30 are inserted into the recess 13 of the carrier 10, the membrane 30 is flush with the carrier 10 at the first open end 11.

As shown in FIG. 1, the carrier 10 preferably has a projection 15 that extends radially with respect to the axis Z so that the insert 20 is secured against an axial displacement along the axis Z at least in one direction.

According to an alternative embodiment (not shown), the carrier 10 has a groove, and the insert 20 has a projection complementary to the groove. If the insert 20 is inserted into the carrier 10 in this embodiment, the insert 20 is secured against an axial displacement along the axis Z.

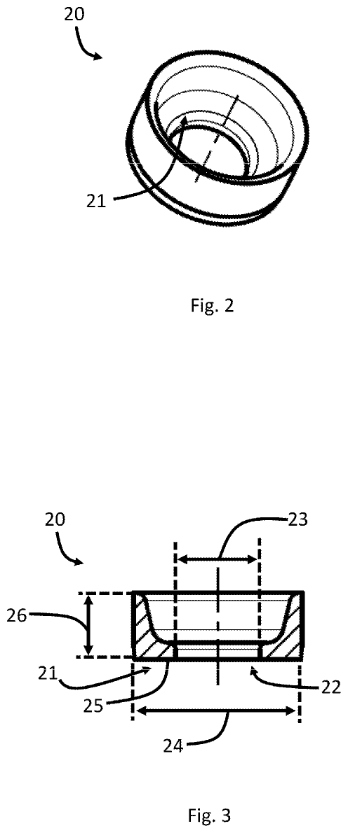

The insert 20 extends in a sleeve-like manner along the axis Z and is arranged in the first open end 11 of the carrier 10. The insert 20 is produced from a second plastic different from the first plastic or from another material (e.g. glass, ceramic, stainless steel, etc.) that has diffusion-inhibiting properties for a softener. The insert 20 preferably comprises the material PEEK or PVDF, PES or PSU, or a material through which the components of the membrane 30 cannot diffuse or diffuse only with difficulty. Such materials generally cannot be integrally bonded to the membrane 30. The insert 20 preferably has an annular shape (see FIG. 2, 4, 6).

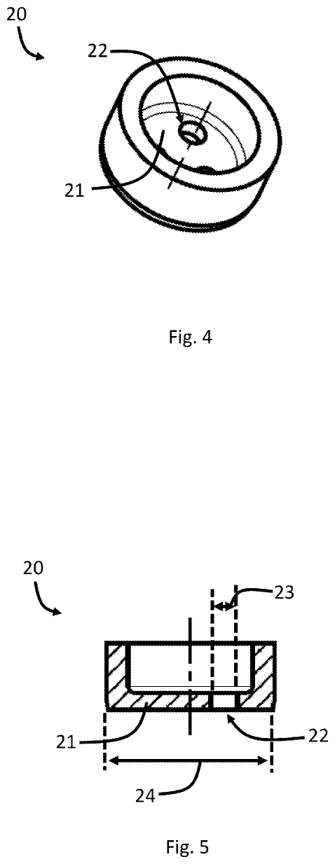

According to the embodiments shown in FIG. 1 to 5, the insert 20 has a bottom 21. At least one passage opening 22 is formed in the bottom 21. The membrane 30 is in electrolytic contact with the electrolyte 40 through the passage opening 22.

As can be seen in FIG. 3, the insert 20 has an insertion diameter 24 that spans an insert surface 25. The insertion diameter 24 is preferably equal to or greater than the recess diameter 16. The at least one passage opening 22 has a passage diameter 23. The passage diameter 23 is, for example, less than 50% of the insert surface 25, preferably less than 10% of the insert surface 25.

The insert 20 is preferably pressed with the carrier 10. According to an alternative embodiment, the insert 20 is glued, welded or otherwise fastened to the carrier 10. The insert 20 is covered by the membrane 30 when the insert 20 is inserted into the carrier 10. The covering by the membrane 30 and the integral bonding of the carrier 10 to the membrane 30 at the process-side opening, i.e., at the first end of the carrier 10, prevents measurement medium from penetrating into the carrier 10. The insert 20 thus has no direct contact with the measurement medium.

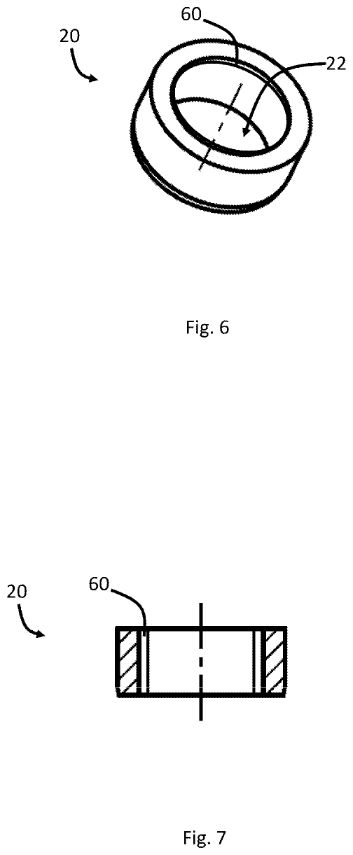

According to an embodiment compatible with the embodiments described above, an adhesive layer 60 is arranged in the insert 20 (see FIGS. 6 and 7). The adhesive layer 60 is arranged on an inner surface of the insert 20. After the membrane 30 has been inserted into the carrier 10 and the insert 20, the inner surface is in contact with the inner surface of the insert 20 (FIG. 1-5) or in contact with the adhesive layer 60 (FIG. 6-7). The adhesive layer 60 is, for example, a fabric. The adhesive layer 60 allows the membrane 30 to better adhere in the insert 20. The risk of the membrane 30 detaching from the ion-sensitive half-cell 1 is thus reduced.

The membrane 30 is arranged in the first open end 11 of the carrier 10 and at least partially in the insert 20. The membrane 30 closes the first open end 11 of the carrier 10 against the penetration of process medium. The membrane 30 is produced from a third plastic different from at least the second plastic. Preferably, the membrane 30 partially comprises the same material as the carrier 10, but with an additional softener. The softener allows particularly good material transport through the membrane 30. The membrane 30 preferably partially comprises the same material as the carrier 10, wherein the membrane 30 additionally contains the softener. Due to the similarity of the base material, e.g. PVC, ASA, ABS, of carrier 10 and the membrane 30, a good integral bond is achieved between the carrier 10 and the membrane 30.

The membrane 30, together with the carrier 10, seals the inner electrolyte and the lead 50 with a high resistance to the process medium.

The electrolyte 40 is arranged in the carrier 10 and is in electrolytic contact with the membrane 30. The electrolyte 40 is, for example, a liquid or gel electrolyte. This is composed according to the usual formulations so that it is compatible both with the lead and with the nature of the ion-sensitive membrane.

The lead 50 is arranged in the carrier 10 and is in electrical contact with the electrolyte 40. In the simplest case, the lead 50 is an Ag/AgCl electrode. However, other lead systems such as, for example, calomel or hexacyanoferrate(II/III) can also be used.

The lead 50 is suitable for being connected to measurement electronics (not shown) in order to determine a voltage potential in a measurement medium using a further ion-sensitive half-cell 1 or a reference half-cell.

Hereinafter, the manufacturing process of the ion-sensitive half-cell 1 will be described.

According to a first step, the carrier 10 described above is provided.

The insert 20 is then inserted into the first open end 11 of the carrier 10. The insert 20 is, for example, pressed, welded, in particular ultrasonically welded or glued in the carrier 10.

If the carrier 10 has a projection 15, the insert 20 is inserted into the carrier 10 up to the projection 15. This allows the insert 20 to be secured by the projection 15 against an axial displacement along the axis Z at least in one direction.

Next, the membrane 30 is introduced into the first open end 11 and the insert 20 such that the first open end 11 is closed by the membrane 30. In this case, the membrane 30 can be produced directly on the first open end 11 of the carrier 10 by introducing the membrane 30, dissolved in a suitable solvent, into the first open end 11 of the carrier 10, allowing the solvent to evaporate, and repeating the process until the membrane 30 is completely produced. Another possibility is to press the membrane 30 into the first open end 11 and the insert 20. According to an alternative variant, the membrane 30 is glued or welded into the carrier 10 or into the insert 20.

The electrolyte 40 is then introduced into the carrier 10 so that the electrolyte 40 is in electrolytic contact with the membrane 30. If the insert 20 has a bottom 21 with a passage opening 22, the electrolyte 40 and the membrane 30 touch, for example, in the passage opening 22. If the electrolyte 40 is liquid, the liquid electrolyte 40 is poured into the carrier 10 through the second open end 12 of the carrier 10. If the second end 12 is closed, the step of introducing the electrolyte 40 takes place before the step of introducing the membrane 30.

Furthermore, a step of introducing a lead 50 into the electrolyte 40 takes place. Of course, the step of introducing the lead 50 can also take place before the step of introducing the electrolyte 40. If the second end 12 is closed, the step of introducing the lead 50 takes place before the step of introducing the membrane 30.

According to an optional step of the manufacturing process, a step of introducing an adhesive layer 60 into the insert 20 is carried out before the step of introducing the membrane 30. The step of introducing an adhesive layer 60 into the insert 20 can also take place after the insert 20 has been introduced into the carrier 10.

The introduction of an adhesive layer 60 comprises, for example, the insertion of a fabric. Alternatively or complementarily, the step of introducing an adhesive layer 60 comprises applying an adhesive layer or other adhesion promoter layer.

1. An ion-selective half-cell comprising:
a carrier that extends in a sleeve-like manner along an axis and has a first open end and a second end opposite the first open end,
an insert that extends in a sleeve-like manner along the axis and is arranged in the first open end,
a membrane that is arranged in the first open end and at least partially in the insert in such a way that the first open end is closed by the membrane,
an electrolyte that is arranged in the carrier and is in electrolytic contact with the membrane, and
a lead that is arranged in the carrier and is in electrical contact with the electrolyte.

2. The ion-selective half-cell according to claim 1, wherein the insert has a bottom in which at least one passage opening is formed, wherein the membrane is in electrolytic contact with the electrolyte through the passage opening.

3. The ion-selective half-cell according to claim 2, wherein the insert has an insert diameter that spans an insert surface, wherein the at least one passage opening defines a passage diameter, and the passage diameter is less than 50% of the insert surface.

4. The ion-selective half-cell according to claim 1, wherein the carrier has a projection that extends radially with respect to the axis so that the insert is secured against an axial displacement along the axis at least in one direction.

5. The ion-selective half-cell according to claim 1, wherein an adhesive layer is arranged in the insert.

6. The ion-selective half-cell according to claim 1, wherein the carrier has a recess at the first open end which extends over a recess length along the axis, wherein the recess is suitable for receiving the insert and the membrane, wherein the insert extends along the first axis with an insert length, and the insert length is smaller than the recess length so that the membrane is partially in direct contact with the carrier.

7. The ion-selective half-cell according to claim 1, wherein the carrier comprises a first plastic that is suitable for being integrally bonded to the membrane, wherein the insert comprises a second plastic different from the first plastic, wherein the membrane comprises a third plastic different from the second plastic.

8. A manufacturing process for an ion-selective half-cell, comprising at least the following steps:
providing a carrier that extends in a sleeve-like manner along an axis and has a first open end and a second open end opposite the first open end,
introducing an insert into the first open end, wherein the insert extends in a sleeve-like manner along the axis,
introducing a membrane into the first open end and the insert such that the first open end is closed by the membrane,
introducing an electrolyte into the carrier so that the electrolyte is in electrolytic contact with the membrane, and
introducing a lead into the electrolyte.

9. The manufacturing process for an ion-selective half-cell according to claim 8, wherein the step of introducing the insert is performed by pressing the insert in the carrier.

10. The manufacturing process from an ion-selective half-cell according to claim 8, wherein a step of introducing an adhesive layer into the insert takes place before the step of introducing the membrane.
